(19) United States
(12) Patent Application Publication
(10) Pub. No.: US 2026/0222323 A1
(43) Pub. Date: Jul. 30, 2026

(54) ESTABLISHING A SERVICE CONNECTION BETWEEN DEVICES BASED ON HISTORICAL DATA

(71) Applicant: International Business Machines Corporation, Armonk, NY (US)

(72) Inventors: Dinesh G. VENKATRAMAN, Bangalore (IN); Ankit CHAHAL, Ghaziabad (IN)

(21) Appl. No.: 19/039,778

(22) Filed: Jan. 28, 2025

(51) Int. Cl. H04L 41/5074; H04L 67/141

(52) U.S. Cl. CPC H04L 41/5074; H04L 67/141

(57) ABSTRACT

A computer-implemented method for assigning cloud support engineers to technical issues is provided. The method includes generating a set of scores based on historical data, where each score corresponds to a cloud support engineer and indicates their ability to resolve technical issues associated with cloud services. The method receives a technical issue indication from a client device and determines technical issue attributes including category, complexity, and geographical region. A primary cloud support engineer is determined based on the technical issue attributes and a first score, while a secondary cloud support engineer is determined based on the technical issue attributes and a second score. The method then causes a service connection to be established between the client device and a device of at least one of the primary or secondary cloud support engineer.

### BACKGROUND

The present invention relates to facilitating processing within a computing environment, and for example, relates to establishing a service connection between devices based on historical data.

### SUMMARY

In one embodiment, a computer-implemented method is provided. In this embodiment, the method includes generating, based on historical data, a set of scores, wherein each score of the set of scores corresponds to a respective cloud support engineer of a plurality of cloud support engineers, wherein each score is indicative of an ability, of the respective cloud support engineer, to resolve one or more technical issues associated with cloud services, and wherein the historical data is associated with a set of technical issue parameters. The method further includes receiving, from a client device, a technical issue indication associated with a technical issue corresponding to a cloud service; determining, based on the technical issue indication, a set of technical issue attributes associated with the technical issue, the set of technical issue attributes corresponding to a subset of the set of technical issue parameters; determining a primary cloud support engineer based on the set of technical issue attributes and a score of the set of scores; determining at least one secondary cloud support engineer based on the set of technical issue attributes and at least one additional score of the set of scores; and causing a service connection to be established between the client device and a device of at least one of the primary cloud support engineer or the at least one secondary cloud support engineer.

In another embodiment, a computer system is provided. In this embodiment, the computer system comprises a storage device; a processor set; one or more computer-readable storage media; and program instructions stored on the one or more computer-readable storage media to cause the processor set to perform operations. The operations include generating, based on historical data, a set of scores, wherein each score of the set of scores corresponds to a respective cloud support engineer of a plurality of cloud support engineers, wherein each score is indicative of an ability, of the respective cloud support engineer, to resolve one or more technical issues associated with cloud services, and wherein the historical data is associated with a set of technical issue parameters. The operations further include receiving, from a client device, a technical issue indication associated with a technical issue corresponding to a cloud service; determining, based on the technical issue indication, a set of technical issue attributes associated with the technical issue, the set of technical issue attributes corresponding to a subset of the set of technical issue parameters; determining a primary cloud support engineer based on the set of technical issue attributes and a score of the set of scores; determining at least one secondary cloud support engineer based on the set of technical issue attributes and at least one additional score of the set of scores; and causing a service connection to be established between the client device and a device of at least one of the primary cloud support engineer or the at least one secondary cloud support engineer.

In yet another embodiment, a computer program product is provided. In this embodiment, the computer program product comprises one or more computer-readable storage media and program instructions stored on the one or more computer readable storage media to perform operations. The operations include generating, based on historical data, a set of scores, wherein each score of the set of scores corresponds to a respective cloud support engineer of a plurality of cloud support engineers, wherein each score is indicative of an ability, of the respective cloud support engineer, to resolve one or more technical issues associated with cloud services, and wherein the historical data is associated with a set of technical issue parameters. The operations further include receiving, from a client device, a technical issue indication associated with a technical issue corresponding to a cloud service; determining, based on the technical issue indication, a set of technical issue attributes associated with the technical issue, the set of technical issue attributes corresponding to a subset of the set of technical issue parameters; determining a primary cloud support engineer based on the set of technical issue attributes and a score of the set of scores; determining at least one secondary cloud support engineer based on the set of technical issue attributes and at least one additional score of the set of scores; and causing a service connection to be established between the client device and a device of at least one of the primary cloud support engineer or the at least one secondary cloud support engineer.

### BRIEF DESCRIPTION OF THE DRAWINGS

FIG. 1A is a block diagram of an example computing environment described herein.

FIG. 1B is a block schematic diagram of an example of the service manager of FIG. 1A.

FIGS. 2A and 2B are flowcharts showing examples associated with establishing a service connection between devices based on historical data, as described herein.

FIGS. 3A-3C are diagrams of example tables associated with establishing a service connection between devices based on historical data, as described herein.

FIG. 4 is a block diagram of an example computing environment in which systems and/or methods described herein may be implemented.

FIG. 5 is a diagram of example components of one or more devices of FIG. 1.

FIG. 6 is a flowchart of an example process associated with establishing a service connection between devices based on historical data, as described herein.

### DETAILED DESCRIPTION

The following detailed description of example implementations refers to the accompanying drawings. The same reference numbers in different drawings may identify the same or similar elements.

In today's cloud computing landscape, enterprises rely heavily on complex distributed systems to deliver services to their customers. These systems often span multiple geographical regions, involve diverse technologies, and require specialized expertise to maintain and troubleshoot. As the scale and complexity of cloud services grow, so does the challenge of efficiently managing technical support for these systems. Traditional methods of assigning support tickets to engineers based on predefined categories, keyword matching, static rosters or predefined rules have become increasingly inadequate in addressing the dynamic nature of cloud service issues.

One of the primary technical challenges in cloud support systems is the efficient matching of incoming technical issues with the most suitable support engineers. Current automated ticket assignment systems typically rely on simplistic rule-based approaches that do not account for the nuanced expertise required for different types of cloud service problems. These systems often fail to consider factors such as the specific category of the issue, its complexity, or the geographical region in which the problem occurs. As a result, tickets may be assigned to engineers who lack the optimal skill set or experience to resolve the issue quickly, leading to prolonged resolution times and decreased customer satisfaction.

Furthermore, existing support systems struggle to adapt to the evolving nature of cloud technologies and the changing skill sets of support engineers. As engineers gain experience in certain areas or as new technologies are introduced, their ability to handle specific types of issues may change. However, current systems lack the capability to dynamically update and refine their assignment algorithms based on historical performance data. This limitation results in suboptimal utilization of the support team's expertise and can lead to bottlenecks in the resolution process, particularly for complex or time-sensitive issues.

The limitations of current cloud support systems also extend to their inability to facilitate collaboration among support engineers. For example, current systems often lack an ability to effectively identify and leverage secondary support resources. In many cases, resolving a complex cloud service issue may require collaboration between multiple engineers with complementary skill sets. However, existing ticket assignment systems typically focus on identifying a single primary engineer, without considering the potential benefits of involving additional experts. This limitation can result in missed opportunities for knowledge sharing, slower resolution times for challenging issues, and increased workload on individual engineers who may struggle to resolve issues outside their primary areas of expertise. Moreover, the absence of a continual learning and feedback loop in existing systems means that valuable insights gained from past resolutions may not be effectively incorporated into future ticket assignments, hindering the overall improvement of the support process.

Implementations of this disclosure address problems such as these by generating a set of scores based on historical data, where each score corresponds to a cloud support engineer's ability to resolve technical issues associated with cloud services. The scores may be derived from historical data related to various technical issue parameters such as, for example, technical issue categories, complexities, or geographical regions, among other examples. When a technical issue indication is received from a client device, the system determines technical issue attributes corresponding to technical issue parameters. Based on these attributes and the generated scores, the system determines a primary cloud support engineer and at least one secondary cloud support engineer. A service connection is then established between the client device and a device of at least one of these engineers.

As used herein, the term “cloud support engineer” refers to a technical professional responsible for resolving issues related to cloud services. This may include, but is not limited to, software developers, network administrators, database administrators, or specialized cloud infrastructure experts. The “historical data” encompasses a wide range of information sources, such as past ticket resolutions, service chat transcripts, runbook repositories, pager duty databases, and employee databases. For example, the system may analyze past performance metrics, resolution times, and customer satisfaction ratings to generate comprehensive engineer profiles.

The technical solution improves upon traditional ticket assignment systems by employing machine learning components to dynamically profile both tickets and engineers. A ticket profiling engine, utilizing a first set of machine learning components, generates ticket profiles based on historical data. Concurrently, an engineer profiling engine, employing a second set of machine learning components, creates engineer profiles. For example, a ticket profile might capture patterns in issue resolution times for different types of cloud service problems, while an engineer profile could reflect an individual's performance across various technical domains and geographical regions. These profiles may be continually refined through a feedback mechanism, enhancing the accuracy of future assignments. Some implementations may include real-time updating of engineer scores based on ongoing ticket resolutions, integration with predictive analytics to anticipate future support needs, or the incorporation of natural language processing to extract key information from unstructured ticket data, among other examples.

The system improves upon traditional ticket assignment methods by incorporating a dynamic scoring mechanism that may consider multiple factors such as issue category, complexity, or geographical region, among other examples. This approach facilitates a nuanced matching process that considers multiple factors simultaneously. The service connection establishment process may involve various technologies, such as secure voice over internet protocol (VOIP) connections, remote desktop applications, or collaborative troubleshooting platforms. In cases where the technical issue falls outside existing categories, the system can assign it to a default category and engineer, while simultaneously initiating a learning process to incorporate the new issue type into its knowledge base for future reference. This adaptive capability allows the system to evolve with the ever-changing landscape of cloud technologies and support requirements.

In some implementations, the system generates a set of scores based on historical data, where each score corresponds to a cloud support engineer's ability to resolve technical issues. Accordingly, an advantage of the score generation based on historical data is improved accuracy in matching engineers to specific technical issues. Additionally, an advantage of the score generation based on historical data is the ability to account for various factors such as issue categories, complexities, or geographical regions simultaneously. Furthermore, an advantage of the score generation based on historical data is its adaptability to changing engineer skills and evolving technical issues over time.

In some implementations, the system determines a primary cloud support engineer and at least one secondary cloud support engineer based on technical issue attributes and scores. Accordingly, an advantage of determining both primary and secondary support engineers is increased flexibility in handling complex or time-sensitive issues. Additionally, an advantage of determining both primary and secondary support engineers is improved collaboration and knowledge sharing among the support team. Moreover, an advantage of determining both primary and secondary support engineers is the ability to provide backup options if the primary engineer is unavailable or requires assistance.

In some implementations, the system utilizes machine learning components for ticket profiling and engineer profiling. Accordingly, an advantage of using machine learning for profiling is the ability to process and analyze large volumes of complex, unstructured data from various sources such as chat transcripts and runbook repositories. Additionally, an advantage of using machine learning for profiling is continuous improvement in categorization and matching accuracy as more data becomes available. Furthermore, an advantage of using machine learning for profiling is the potential to identify non-obvious patterns or relationships in the data that may not be apparent through manual analysis.

In some implementations, the system includes a feedback mechanism that continuously refines the machine learning components based on the outcomes of resolved issues. Accordingly, an advantage of the continuous feedback mechanism is the system's ability to adapt to changing technologies and emerging issue patterns in cloud services. Additionally, an advantage of the continuous feedback mechanism is improved accuracy in future ticket assignments as the system learns from past resolutions. Furthermore, an advantage of the continuous feedback mechanism is the potential for identifying areas where support engineers may need additional training or resources, leading to overall improvement in the support team's capabilities.

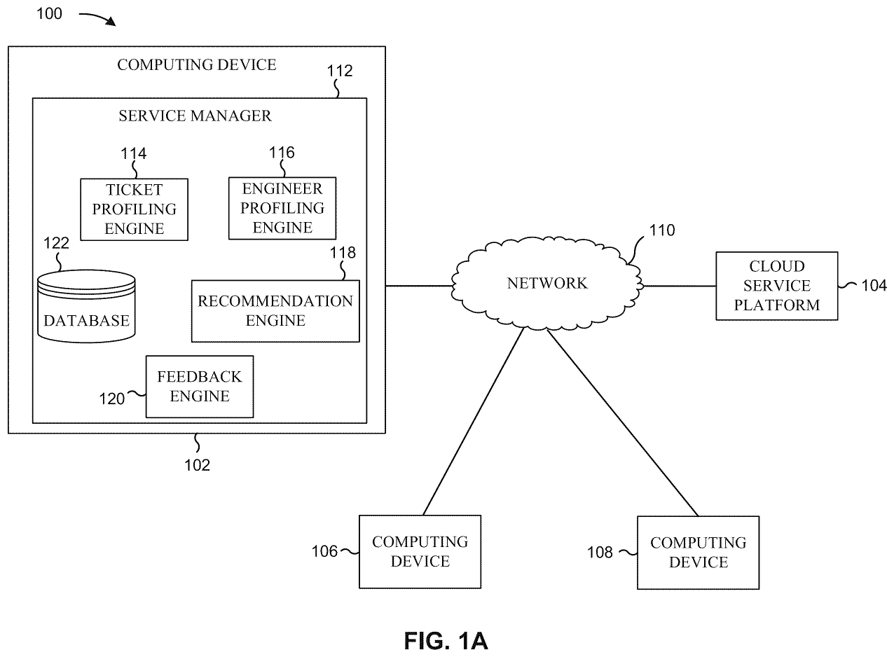

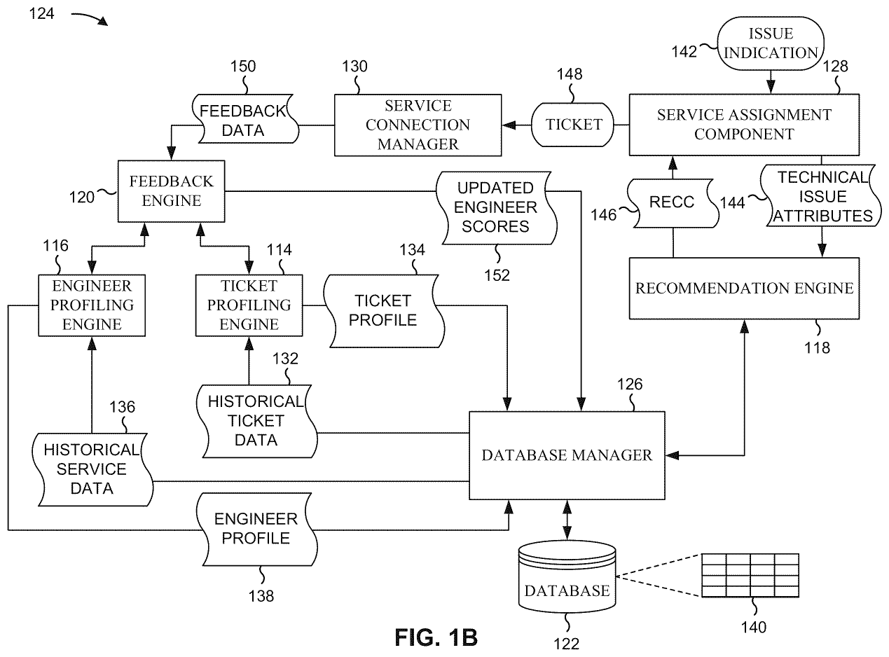

FIG. 1A is a block diagram of an example computing environment 100, which can be or include a distributed computing system, a cloud computing system, and/or a clustered computing system, among other examples. As shown, the computing environment 100 includes a computing device 102, a cloud service platform 104, and computing devices 106 and 108, communicatively coupled by a network 110.

The computing environment 100 may be implemented using a hardware environment that includes computer system components, such as general-purpose computers, dedicated computer systems, peripheral devices, components, and modules, and/or a combination thereof. In some implementations, the computing environment 100 may be implemented within one or more cloud computing environments, where various components of the computing environment 100 may be executed in various configurations, including in parallel. In some implementations, one or more components of the computing environment 100 can be implemented using one computing device or a combination of several interconnected computing devices.

The computing device 102 may be any type of computing device capable of processing data and executing software applications. For example, the computing device 102 may be a server, a desktop computer, a laptop computer, a tablet computer, a smartphone, or any other suitable computing device. In some implementations, the computing device 102 may be a virtual machine running on a physical server or a cloud-based computing instance.

The cloud service platform 104 may be a distributed computing platform that provides various cloud-based services to users. In some implementations, the cloud service platform 104 may include multiple interconnected servers, data centers, and other computing resources distributed across various geographical locations. The cloud service platform 104 may offer services such as infrastructure as a service (IaaS), platform as a service (PaaS), software as a service (SaaS), or any combination thereof.

Computing devices 106 and 108 may represent client devices or other computing systems that interact with the computing environment 100. These devices may be, for example, personal computers, laptops, smartphones, tablets, or any other type of computing device capable of connecting to the network 110 and communicating with other components of the computing environment 100. In some implementations, computing devices 106 and 108 may be IoT (Internet of Things) devices or specialized hardware designed for specific tasks within the computing environment 100.

The network 110 may be any type of communication network that allows data exchange between the components of the computing environment 100. For example, the network 110 may include one or more of a local area network (LAN), a wide area network (WAN), the Internet, a cellular network, a satellite network, or any combination thereof. In some implementations, the network 110 may use various communication protocols, such as TCP/IP, HTTP, HTTPS, FTP, or any other suitable protocol for data transmission.

The computing device 102 includes a service manager 112, which may be a software component responsible for managing various aspects of the computing environment 100. The service manager 112 may coordinate the operations of other components within the computing device 102 and may interact with external components such as the cloud service platform 104 and computing devices 106 and 108. In some implementations, the service manager 112 may be implemented as a microservice architecture, with multiple independent services working together to provide overall functionality.

The service manager 112 includes a ticket profiling engine 114, an engineer profiling engine 116, a recommendation engine 118, a feedback engine 120, and database 122. In some implementations, any two or more of the ticket profiling engine 114, engineer profiling engine 116, recommendation engine 118, feedback engine 120, and database 122 may be combined into a single component. Conversely, in some implementations, any of the ticket profiling engine 114, engineer profiling engine 116, recommendation engine 118, feedback engine 120, and database 122 may be divided into three or more components.

The ticket profiling engine 114 may be configured to analyze and categorizing technical support tickets based on historical data. In some implementations, the ticket profiling engine 114 may include a first set of machine learning (ML) components. The first set of ML components may include one or more ML components. An ML component refers to software and/or hardware capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, large language models (LLMs), and/or support vector machines (SVMs), among other examples.

The ticket profiling engine 114 may use the first set of ML components to generate ticket profiles by analyzing and categorizing technical support tickets. The first set of ML components may take, as input, historical ticket data. Historical ticket data may be obtained from any number of various sources associated with the service manager 112. Historical ticket data may include, for example, historical ticket content, past ticket resolutions, service chat transcripts, runbook repositories, pager duty databases, and employee databases, among other examples.

Historical ticket content may include any type of relevant data that is associated with historical tickets such as, for example, ticket descriptions/notes (text), tickets notes (text), tickets notes (JSON), ticket transcripts, ticket files, ticket images, ticket notes, ticket tags, ticket biometrics information, comments, emails, service updates, comments, customer feedback, service alerts, and/or other types of data that may be associated with a ticket. Tickets notes (text), tickets notes (JSON), and ticket files may refer to the actual text or JSON (JavaScript Object Notation) formatted strings that make up the ticket content. Ticket transcripts, ticket files, ticket images, ticket notes, ticket tags, and ticket biometrics may include actual audio, video, image, or biometric data.

Past ticket resolutions may refer to any type of response to a technical support issue associated with a ticket. Past ticket resolutions can include, for example, the resolution of the issue by a support engineer (e.g., a primary cloud support engineer or a secondary cloud support engineer), the resolution of the issue by support personnel other than a support engineer that is currently responsible for the ticket (e.g., an escalation team), or the resolution of the issue by one or more other automated tools that the system can utilize to resolve the issue without a support engineer.

Service chat transcripts may refer to any type of text data sent as part of a chat between, for example, a client computing 106 or 108 and a support system using, for example, natural language processing (NLP) techniques. For example, service chat transcripts can include messages in the form of text describing a technical issue (the “ticket content”), replies to previous messages in the form of replies (the “ticket notes”), messages in the form of plain text associated with one or more images (e.g., an attached image or link to a file or webpage), and/or other types of data exchanges associated with a customer request for service (the “service chat content”).

Runbook repositories may include any type of data stored in the form of text or files, that can be used to resolve a ticket. In some implementations, runbooks are typically used in troubleshooting an issue with a service that appears to be non-responsive or non-interactive. In some implementations, runbook repositories may include runbooks for different types of tickets (e.g., ticket types). A runbook can be created and maintained by subject-matter experts and/or users of a support system associated with the computing environment 100.

Pager duty databases may include any type of data stored in the form of text or files, that can be used to resolve a ticket. In some implementations, pager duty databases are typically used in troubleshooting an issue with a service that appears to be non-responsive. In some implementations, pager duty databases may include pager duty entries, which may include, for example, the names of pager operators, the pager operator status, the operator's shift, the operator's working/idle time, and the like. In this context, a pager refers to a human operator at an agent station that can be used, for example, to resolve a problem with a customer's service.

Employee databases may include any type of data associated with individual cloud support engineers. For example, an employee database can include, for a particular cloud support engineer, an indication of the name or identifier of the particular cloud support engineer, information that indicates whether the particular cloud support engineer is currently available to resolve technical issues, information that indicates whether the particular cloud support engineer is currently unavailable to resolve technical issues, and the like.

To generate ticket profiles, the ticket profiling engine 114 may parse, analyze, and process, historical ticket data using the first set of ML components. For example, ML components may be used to determine technical issue attributes associated with a ticket. Technical issue attributes associated with a ticket may correspond to technical issue parameters such as, for example, a ticket issue category, a ticket issue complexity, and/or a ticket issue geographical region. Technical issue attributes may include any number of other attribute characteristics associated with a ticket which may be applicable to determining whether the ticket should be routed to one or more of a primary support engineer and a secondary support engineer to resolve the ticket, as described herein.

In some implementations, technical issue parameters may include additional attributes that further characterize the nature and context of the technical issue. These parameters may include, for example, the urgency level of the ticket, the estimated time to resolution, the specific cloud service or product involved, the customer's service level agreement (SLA) tier, the ticket's priority level, the technical domain expertise required (e.g., networking, database, security), the language preference of the customer, the time zone of the reported issue, the customer's industry sector, the scale of the impact (e.g., single user, department-wide, or organization-wide), the frequency of occurrence, and the potential business impact. In some cases, the technical issue parameters may also encompass the specific error codes or log messages associated with the issue, the software version or hardware configuration involved, the recent system changes or updates that may be relevant, and the historical context of similar issues for the same customer or within the same service area. These additional parameters may help in creating a more comprehensive profile of the technical issue, potentially leading to more accurate matching with appropriate support engineers and improved resolution strategies.

The ticket profiling engine 114 may process historical ticket content, for example, by identifying keywords (e.g., service update keywords, error keywords, resolution keywords, etc.) in the historical ticket content. Service update keywords may include the phrase “update” or any number of other service change keywords which might appear in historical ticket content. Error keywords may include the phrase “error” or any number of other error keywords which might appear in historical ticket content. Resolution keywords may include the phrase “resolve” or any number of other resolution keywords which might appear in historical ticket content.

In some implementations, the ticket profiling engine 114 may identify one or more ticket issue categories, based on keywords contained in the historical ticket content. Ticket issue categories may include, for example, “hardware issues,” “network issues,” “data connectivity issues,” “security issues,” or any number of other categories which may occur in historical ticket content.

In some implementations, natural language processing (NLP) techniques may be used to determine the most suitable ticket issue category given historical ticket content. Based on the historical ticket content, the ticket profiling engine 114 may, for example, select the most frequent ticket issue category from a set of frequently occurring issue categories. For example, the ticket profiling engine 114 may determine that the most frequently occurring issue categories include “hardware issues,” “network issues,” and “data connectivity issues” based on the occurrence of keywords containing “hardware,” “network,” and/or “data” in the historical ticket content. Any number of other NLP techniques may be used to identify possible ticket issue categories based on text content in the historical ticket content. For example, NLP techniques, including text classification and named entity recognition, may be applied to extract key information from ticket descriptions, such as affected services, error codes, or specific technical terms.

In some implementations, the ticket profiling engine 114 may utilize supervised learning techniques such as support vector machines (SVMs) or random forests to classify tickets into predefined categories based on their content and metadata. These algorithms may be trained on historical ticket data, learning to recognize patterns and features that distinguish different types of issues. In some implementations, the engine may incorporate unsupervised learning methods like clustering algorithms (e.g., K-means or hierarchical clustering) to identify natural groupings of similar tickets, potentially uncovering new issue categories or trends. The engine may also leverage deep learning models, such as recurrent neural networks (RNNs) or transformers, to capture complex relationships in ticket text and improve categorization accuracy. In some implementations, the ticket profiling engine 114 may use ensemble methods, combining multiple algorithms to enhance overall performance and robustness in ticket classification and attribute extraction.

In some implementations, the ML components may identify a complexity associated with a historical ticket based on the historical ticket content. For example, the ML components may identify one or more complexity characteristics associated with a historical ticket based on historical ticket content. Complexity characteristics associated with a ticket may include, for example, “high complexity,” “medium complexity,” or “low complexity.” For example, the ticket profiling engine 114 may parse, analyze, and process, historical ticket content using the ML components to determine that the ticket content associated with a historical ticket includes the phrase, “data recovery from hard disk errors,” which may indicate, for example, a medium complexity.

In some implementations, the ticket profiling engine 114 may include one or more neural networks trained to determine technical issue complexity based on historical ticket content. For example, the ticket profiling engine 114 may include a convolutional neural network (CNN) trained to determine technical issue complexity based on historical ticket content. The CNN may be or include, for example, a recurrent neural network (RNN) and/or a long short-term memory (LSTM) neural network. Technical issue complexity may be determined based on any number of characteristics or factors associated with historical ticket content. For example, technical issue complexity may be determined based on, a subject matter expert or a user of the service manager 112 based on, for example, historical technical issues for a similar service or similar services. In some implementations, technical issue complexity may be related to whether one or more components of a ticket can be fixed or resolved, whether a large number of data recovery attempts were necessary, and/or whether the data recovery attempts resulted in a successful data recovery, among other examples.

In some implementations, the ticket profiling engine 114 may include one or more neural networks trained to identify one or more geographical regions associated with historical ticket content. For example, the ticket profiling engine 114 may extract a ticket issue geographical region from a location field included in ticket content associated with the ticket. In some implementations, the ticket profiling engine 114 may include one or more neural networks trained to identify one or more geographical regions associated with historical ticket content based on, for example, historical ticket location data, language and dialect data, and/or location data, among other examples.

In some implementations, the ticket profiling engine 114 may analyze temporal patterns associated with historical ticket data to determine technical issue parameters related to time-based factors. For example, the engine may identify recurring issues that tend to arise during specific time periods, such as peak usage hours, maintenance windows, or seasonal fluctuations. This analysis may involve examining timestamp data associated with ticket creation, updates, and resolution to uncover patterns that could inform the prioritization and assignment of future tickets. The ticket profiling engine 114 may use time series analysis techniques or periodic pattern mining algorithms to detect these temporal trends, which may be incorporated as additional technical issue parameters.

The ticket profiling engine 114 may examine the interdependencies between different components or services mentioned in historical ticket data to determine technical issue parameters related to system architecture and service relationships. By analyzing the co-occurrence of different services or components in ticket descriptions, the ticket profiling engine 114 may identify clusters of related issues or potential cascading effects. This information may be used to create a parameter that represents the scope or potential impact of an issue across the system architecture. Graph-based algorithms or association rule mining techniques may be employed to uncover these relationships and quantify their strength, providing valuable context for ticket assignment and resolution strategies.

In some cases, the ticket profiling engine 114 may incorporate sentiment analysis techniques to determine technical issue parameters related to customer satisfaction or urgency. By analyzing the language and tone used in customer-submitted tickets or subsequent communications, the ticket profiling engine 114 may assign sentiment scores that reflect the customer's level of frustration, urgency, or satisfaction with the service. Natural language processing models, such as BERT or other transformer-based architectures, may be fine-tuned on domain-specific data to accurately capture the nuances of technical support communications. These sentiment-based parameters may help prioritize tickets and inform the selection of support engineers with appropriate communication skills for handling sensitive or high-stakes issues.

Based on the technical issue attributes, the ticket profiling engine 114 may generate, for each historical ticket, a ticket profile. A ticket profile may indicate, for example, one or more technical issue parameter values. The technical issue parameter values may be indicative of ticket issue categories, one or more ticket issue complexities, and/or one or more ticket issue geographical regions. Based on the technical issue attributes, the ticket profiling engine 114 may generate, for each historical ticket, a ticket profile. A ticket profile may indicate, for example, one or more technical issue parameter values. The technical issue parameter values may be indicative of ticket issue categories, ticket issue complexities, ticket issue geographies, customer-reported ticket statuses, ticket priorities, and/or language preferences, among other examples. Generation of a ticket profile may include, for example, mapping one or more values of ticket attribute information from historical ticket content to one or more of a respective technical issue parameter value, a respective ticket issue category, a respective ticket issue complexity, a respective ticket issue geographical region, a respective customer-reported ticket status, a respective ticket priority, and a respective language preference. A ticket profile may be generated in any number of formats such as, for example, a textual format (e.g., “hardware issues with network interface A”), a tabular format (e.g., table rows that each correspond to a respective ticket), and/or any other format.

The historical ticket data, the technical issue attributes, and/or the ticket profiles may be stored in the database 122. In some implementations, the database 122 may include a ticket profile repository that maintains ticket profiles, historical technical issue categories, historical technical issue complexities, and/or historical geographical regions. The database 122 may include any number of different types of databases such as, for example, a relational database, a flat database, a columnar database, or an object database, among other examples.

The engineer profiling engine 116 may be configured to generate engineer profiles for cloud support engineers. For example, the engineer profiling engine 116 may include a second set of ML components. The second set of ML components may include one or more ML components. The engineer profiling engine 116 may be configured to analyze the skills, experience, and performance of cloud support engineers. The engineer profiling engine 116 may use various data sources, such as historical ticket resolution data, performance reviews, and self-reported skills, to create comprehensive profiles of support engineers. In some implementations, the engineer profiling engine 116 may use collaborative filtering techniques to identify similarities between engineers and predict their ability to handle specific types of technical issues.

In some implementations, the engineer profiling engine 116 may use the second set of ML components to generate engineer profiles based on historical service data. Historical service data may be obtained from any number of various sources associated with the service manager 112. Historical service data may include, for example, ticket resolutions, service chat transcripts, runbook repositories, pager duty databases, and employee databases, among other examples.

To generate engineer profiles, the engineer profiling engine 116 may parse, analyze, and process, historical service data using the second set of ML components. For example, ML components may be used to determine cloud support engineer attributes associated with a cloud support engineer. The engineer attributes associated with a cloud support engineer may include, for example, an availability of the cloud support engineer, one or more skills of the cloud support engineer, one or more experiences of the cloud support engineer, and/or one or more performance metrics of the cloud support engineer, among other examples.

In some implementations, the engineer profiling engine 116 may utilize the second set of ML components to analyze historical service data and generate comprehensive engineer profiles. These ML components may include supervised learning algorithms, such as gradient boosting machines or neural networks, trained on past performance data to predict an engineer's ability to handle various types of technical issues. The ML components may process features extracted from historical ticket resolutions, including resolution time, customer satisfaction scores, and the complexity of issues resolved, to build a model of each engineer's strengths and weaknesses across different technical domains.

The second set of ML components may incorporate NLP techniques to analyze unstructured data sources, such as service chat transcripts and runbook entries. These techniques may be used to identify key skills and knowledge areas demonstrated by engineers during their interactions with customers or in their contributions to knowledge bases. In some implementations, the ML components may employ collaborative filtering algorithms to identify patterns in how engineers with similar skill sets perform across different types of issues, allowing the system to make more accurate predictions about an engineer's potential performance on new or uncommon issue types.

In some implementations, the engineer profiling engine 116 may use reinforcement learning techniques within the second set of ML components to continually refine and update engineer profiles based on ongoing performance data. As engineers resolve new tickets and receive feedback, the ML components may adjust their models to reflect changes in an engineer's skills, expertise, or efficiency over time. This adaptive approach may allow the system to maintain up-to-date and accurate engineer profiles, taking into account factors such as skill development, changes in technology, and evolving customer needs. The engineer profiling engine 116 may use anomaly detection algorithms to identify unusual patterns in an engineer's performance, which may indicate areas for improvement or specialized expertise that could be leveraged for specific types of technical issues.

The engineer profiles may be stored in the database 122. In some implementations, the database 122 may include an engineer profile repository that maintains engineer profiles. The engineer profiling engine 116 may update engineers profiles to include, for example, a current availability of the cloud support engineer, the one or more skills of the cloud support engineer, the one or more experiences of the cloud support engineer, and/or the one or more performance metrics of the cloud support engineer. Any number of factors or characteristics associated with a cloud support engineer may be included in the engineer profiles.

The engineer profiling engine 116 and/or a database manager 126 (shown in FIG. 1B) may be configured to determine, based on the engineer profiles, a set of scores, where each score is indicative of an ability, of the respective cloud support engineer, to resolve one or more technical issues associated with cloud services. Thus, each cloud support engineer may be associated with a respective set of scores, with each score being indicative of an ability, of the respective cloud support engineer, to resolve one or more technical issues associated with cloud services. The scores may be, for example, numerical scores (e.g., a high score indicates a high ability of the cloud support engineer to resolve one or more technical issues associated with cloud services; a low score indicates a low ability of the cloud support engineer to resolve one or more technical issues associated with cloud services). The scores may be or include, for example, Boolean scores (e.g., a Boolean score of “TRUE” indicates that a cloud support engineer has the ability to resolve one or more technical issues associated with cloud services, and a Boolean score of “FALSE” indicates that a cloud support engineer does not have the ability to resolve one or more technical issues associated with cloud services) and/or categorical scores (e.g., a categorical score of “LOW” indicates that a cloud support engineer has the ability to resolve one or more technical issues associated with cloud services, and a categorical score of “HIGH” indicates that a cloud support engineer does not have the ability to resolve one or more technical issues associated with cloud services).

In some implementations, a score of the set of scores may be based on an engineer profile associated with a cloud support engineer and one or more of a ticket issue category, a ticket issue complexity, and a ticket issue geographical region. Thus, the score of the set of scores may be indicative of the ability, of the cloud support engineer, to resolve technical issues associated with a ticket corresponding to a set of technical issue parameter values associated with the ticket. The technical issue parameter values, which may be referred to as “technical issue attributes,” may be indicative of the ticket issue category, ticket issue complexity, a ticket issue geographical region, a ticket issue status, a ticket issue priority, or a ticket issue language, among other examples. For example, the set of scores may include at least one of a ticket issue category score, a ticket issue complexity score, and a ticket issue geographical region score.

The set of scores may be stored in the database 122. For example, the database 122 may include a score table that is populated with the scores generated based on the engineer profiles. For example, the score table may include (e.g., in a same record or in a different record) the set of scores, a cloud support engineer identifier, and at least one of the ticket issue category, the ticket issue complexity, and the ticket issue geographical region.

The recommendation engine 118 may be configured to determine, based on the set of scores and technical issue attributes associated with a new technical issue, a primary cloud support engineer and at least one secondary cloud support engineer. The recommendation engine 118 may use the outputs from both the ticket profiling engine 114 and the engineer profiling engine 116 to make intelligent assignments. In some implementations, the recommendation engine 118 may employ a multi-criteria decision-making algorithm that considers factors such as engineer expertise, workload, availability, and geographical location when making assignments. In some implementations, the recommendation engine may consider a rank associated with each cloud support engineer of a set of cloud support engineers to facilitate effective assignment.

In some implementations, the recommendation engine 118 may utilize a third set of ML components to determine primary and/or secondary cloud support engineers for a new technical issue. This third set of ML components may include advanced algorithms such as deep neural networks, ensemble methods, or reinforcement learning models that are specifically trained to match technical issues with the most suitable support engineers. The ML components may take as input the technical issue attributes, engineer profiles, historical performance data, and current workload information to generate optimal engineer assignments.

In some implementations, the third set of ML components may employ a two-stage approach for determining engineer assignments. In the first stage, the ML components may use a ranking algorithm to generate a shortlist of potential engineers based on their scores and relevance to the technical issue at hand. The second stage may involve a more detailed analysis of the shortlisted engineers, considering factors such as their current availability, recent performance trends, and potential for knowledge transfer. This two-stage approach may allow for a balance between computational efficiency and assignment accuracy.

The feedback engine 120 may be designed to continually improve the performance of the overall system. It may collect data on the outcomes of ticket resolutions, including resolution time, customer satisfaction, and any feedback provided by users or engineers. In some implementations, the feedback engine 120 may use reinforcement learning techniques to adjust the weights and parameters used by other components of the system, such as the recommendation engine 118, based on the success or failure of previous assignments. As engineers interact with and resolve technical issues, the system may update its models to reflect the latest performance data and emerging patterns. This adaptive approach may enable the recommendation engine to respond dynamically to changes in engineer skills, issue complexities, and overall support team dynamics, potentially leading to more effective and efficient support operations over time.

The feedback engine 120 may be designed to continually refine and optimize the performance of the cloud support system through iterative learning processes and/or updating processes. In some implementations, the feedback engine 120 may be configured to update various components of the system based on the outcomes of resolved tickets. The feedback engine 120 may analyze resolution data, customer satisfaction ratings, and other feedback metrics to refine the information stored in the database 122. For instance, the feedback engine 120 may update ticket data in the database 122 to reflect new patterns or trends in technical issues. The ticket profiles stored in the database 122 may be adjusted to incorporate newly identified attributes or to modify existing categorizations based on resolution outcomes. Similarly, engineer profiles may be updated to reflect recent performance, newly acquired skills, or changes in expertise areas. The feedback engine 120 may also recalculate and update the scores associated with each engineer based on their latest performance metrics and the outcomes of their most recent ticket resolutions. This continual updating process may help maintain the accuracy and relevance of the system's data, potentially improving the quality of future ticket assignments and support operations.

In some implementations, the feedback engine 120 may utilize one or more techniques to adapt and improve the system's decision-making capabilities over time. These techniques may include, but are not limited to, reinforcement learning, federated learning, supervised learning, unsupervised learning, and other machine learning approaches. The specific techniques employed may be selected based on the particular requirements and constraints of the cloud support system.

Reinforcement learning techniques may be employed by the feedback engine 120 to adjust the weights and parameters used by other components of the system, such as the recommendation engine 118. For example, the feedback engine may implement a Q-learning algorithm to optimize the engineer assignment process. In this approach, each assignment decision may be treated as an action, with the resulting outcome (e.g., resolution time, customer satisfaction score) serving as the reward signal. The Q-learning algorithm may iteratively update a value function that estimates the long-term reward of each action in different states, allowing the system to make increasingly optimal decisions over time. In some implementations, the feedback engine may utilize policy gradient methods, such as REINFORCE or Proximal Policy Optimization (PPO), to directly optimize the policy for selecting engineers based on the observed outcomes of previous assignments.

In some aspects, the feedback engine 120 may incorporate federated learning techniques to leverage distributed data sources while maintaining privacy and reducing communication overhead. For instance, the service manager 112 may implement a federated averaging algorithm where local models are trained on computing devices associated with individual support centers or geographical regions, and only the model updates are shared with a central server. This approach may allow the system to benefit from a diverse range of experiences across different parts of the organization without the need to centralize sensitive data. The feedback engine may also employ techniques like Federated Stochastic Gradient Descent (FedSGD) or Federated Averaging with Momentum (FedAvgM) to improve the convergence and stability of the federated learning process.

The feedback engine 120 may utilize multi-armed bandit algorithms as part of its reinforcement learning strategy to balance exploration and exploitation in engineer assignments. For example, an epsilon-greedy algorithm may be implemented where the system occasionally assigns tickets to engineers with lower scores to explore potential improvements in their performance. In some implementations, a Thompson Sampling approach may be used to model the uncertainty in engineer performance and make probabilistic assignments that balance the trade-off between exploiting known high-performing engineers and exploring potentially underutilized talent.

In some implementations, the feedback engine 120 may employ transfer learning techniques in conjunction with federated learning to improve the system's performance across different domains or regions. For instance, a model trained on resolving network issues in one geographical region may be used as a starting point for training models in other regions with similar infrastructure. The feedback engine may utilize techniques like Federated Transfer Learning (FTL) or Federated Multi-Task Learning (FMTL) to efficiently share knowledge across different parts of the organization while adapting to local specificities. This approach may accelerate the learning process for new or less common types of technical issues by leveraging relevant experience from other domains.

The database 122, as indicated above, may store various types of data used by the components of the service manager 112. This may include historical ticket data, engineer profiles, performance metrics, and other relevant information. In some implementations, the database 122 may be a distributed database system capable of handling large volumes of data across multiple nodes. In some implementations, the database 122 may employ advanced indexing and querying techniques to ensure fast and efficient data retrieval for the various components of the system. The database 122 may be implemented using any appropriate database technology, such as relational databases, object databases, document databases, or graph databases, among other examples.

FIG. 1B is block schematic diagram of an example 124 associated with establishing a service connection between devices based on historical data. The example 124 may depict operations of the service manager 112 shown in FIG. 1A. As shown, the service manager 124 may include several additional components that work together to manage the technical support process. These components may include a database manager 126, a service assignment component 128, and a service connection manager 130. In some implementations, any two or more of the database manager 126, the service assignment component 128, and the service connection manager 130 may be combined into a single component. In some implementations, any of the database manager 126, the service assignment component 128, and the service connection manager 130 may be divided into three or more components. In some implementations, the service manager 112 may include any number of components such as the components described herein and with reference to FIG. 1B. For example, in some implementations, the service manager may include a number of ticket profiling engines, a number of engineer profiling engines, a number of recommendation engines, a number of feedback engines, a number of databases, and any other number of additional components.

The database manager 126 may be configured to interface with the database 122 and manage data operations. The database manager 126 may handle tasks such as data insertion, retrieval, updating, organization, or deletion. In some implementations, the database manager 126 may implement caching mechanisms to improve performance and reduce the load on the database. In some implementations, the database manager 126 may handle data replication and consistency across distributed database nodes if applicable. In some implementations, the database manager 126 may be or include a specialized database service that provides APIs for data querying, such as SQL or MapReduce. In some implementations, the database manager 126 may include tools for data management and security, such as access control, authentication, and encryption.

The service assignment component 128 works closely with the recommendation engine 118 to assign incoming technical issues to appropriate support engineers. This component may implement various assignment strategies, such as round-robin, load-balancing, or priority-based assignment, depending on the specific requirements of the support organization. In some implementations, the service assignment component 128 may also handle escalation procedures when issues cannot be resolved within specified time frames.

The service connection manager 130 may be configured to establish and manage connections between client devices and support engineer devices. This may involve setting up secure communication channels, managing authentication and authorization, and ensuring proper data exchange between parties. In some implementations, the service connection manager 130 may support various communication protocols and methods, such as voice calls, video conferencing, screen sharing, or text-based chat, to facilitate effective communication between users and support engineers. In some implementations, the service connection manager 130 may be configured to provide notification services to clients and support engineers alerting them of newly generated service connections or service requests.

In operation, the ticket profiling engine 114 may obtain historical ticket data 132 from the database 122 via the database manager 126. The ticket profiling engine 114 may process the historical ticket data 132 using the first set of ML components, as described herein, to generate ticket profiles 134. The ticket profiles 134 may be stored in the database 122 via the database manager 126.

The engineer profiling engine 116 may obtain historical service data 136 from the database 122 via the database manager 126. The engineer profiling engine 116 may process the historical service data 136 using the second set of ML components, as described herein, to generate engineer profiles 138. The engineer profiles 138 may be stored in the database 122 via the database manager 126.

The engineer profiling engine 116 and/or the database manager 126 may determine a set of scores for respective support engineers and may store the sets of scores as one or more score tables 140 in the database 122. The score tables 140 may be stored in any number of records in any number of different tables in the database 122. A score is indicative of an ability, of the respective support engineer, to resolve one or more technical issues associated with cloud services.

When a computing device 106 or 108 (shown in FIG. 1A) associated with a client of the cloud service platform 104 encounters a technical issue, the computing device 106 or 108 may send a technical issue indication 142 to the cloud service platform 104. The technical issue indication 142 may be sent over a network 110. In some implementations, the technical issue indication 142 may include an identifier of the computing device 106 or 108 sending the technical issue indication. In some implementations, the technical issue indication 142 may include an identifier of the technical issue that has occurred on the computing device 106 or 108. In some implementations, the technical issue indication 142 may include a textual description (e.g., a problem type or a problem severity) of the technical issue that has occurred on the computing device 106 or 108 that resulted in the technical issue indication.

The technical issue indication 142 may be received by the service manager 112 at the service assignment component 128. The service assignment component 128 may be configured to process the technical issue indication 142 to determine a set 144 of technical issue attributes. The set 144 of technical issue attributes may be indicative of the technical issue that has occurred on the computing device 106 or 108 and is associated with the technical issue indication. In some implementations, the set 144 of technical issue attributes may be indicative of one or more technical issue parameters such as, for example, a ticket issue category, a ticket issue complexity, or a ticket issue geographical region, among other examples. An attribute that is indicative of a technical issue parameter, may refer to an attribute that indicates, explicitly or implicitly, the a value of the technical issue parameter. For example, the set 144 of technical issue attributes may be determined by parsing the technical issue textual description included in the technical issue indication 142.

In some implementations, determining the set 144 of technical issue attributes may include providing the technical issue textual description to the ticket profiling engine 114, which may be or include one or more ML components (e.g., described herein) that performs a NLP process upon the technical issue textual description to determine technical issue attributes. In some implementations, the service assignment component 128 may include one or more ML components configured to determine the set 144 of technical issue attributes based on the technical issue textual description.

The service assignment component 128 may provide the set 144 of technical issue attributes to the recommendation engine 118. Based on the set 144 of technical issue attributes, the recommendation engine 118 may determine a primary cloud support engineer and at least one secondary cloud support engineer. For example, the recommendation engine 118 may utilize the third set of ML components to determine the primary and/or secondary cloud support engineers based on the set 144 of technical issue attributes associated with the new technical issue, as described herein in reference to FIG. 1A.

The recommendation engine 118 may provide a recommendation 146 to the service assignment component 128. The recommendation 146 may indicate the primary cloud support engineer and/or the at least one secondary cloud support engineer. For example, the recommendation 146 may include an engineer identifier and/or an engineer profile identifier associated with the primary cloud support engineer and/or the at least one secondary cloud support engineer. In some implementations, the recommendation 146 may include an indication of an ability, of the primary cloud support engineer and/or the at least one secondary cloud support engineer, to resolve one or more technical issues associated with cloud services.

Based on the recommendation 146, the service assignment component 128 may be configured to generate a ticket 148. The ticket may include, for example, a service connection request. The ticket 148 may be provided to the service connection manager 130. Based on the ticket 148, the service connection manager 130 may cause a service connection to be established between the computing device 106 or 108 and a computing device associated with the primary cloud support engineer and/or the at least one secondary cloud support engineer. The service connection may allow the computing device 106 or 108 and the computing device associated with the primary cloud support engineer and/or the at least one secondary cloud support engineer to electronically communicate with each other to resolve the technical issue. In some implementations, the service connection manager 130 may provide one or more notifications to the computing device 106 or 108 and/or the computing device associated with the primary cloud support engineer and/or the at least one secondary cloud support engineer notifying them of the service connection or service request.

Based on the support service, the service connection manager 130 may obtain feedback data 150, which may be provided to the feedback engine 120. The feedback engine 120 may use the feedback data 150 to perform one or more operations to improve the operations of the service manager 112. In some implementations, the operations performed by the feedback engine 120 may be used to update one or more of the ticket profiling engine 114, the engineer profiling engine 116, the recommendation engine 118, and/or the database manager 126. For example, the feedback engine 120 may include an ML training component that can be used to train one or more ML models associated with the ticket profiling engine 114, the engineer profiling engine 116, and/or the recommendation engine 118. The feedback engine 120 may update, for example, the historical ticket data 132, the ticket profiles 134, the historical service data 136, the engineer profiles 138, and/or the score tables based at least in part on, for example, the feedback data 150.

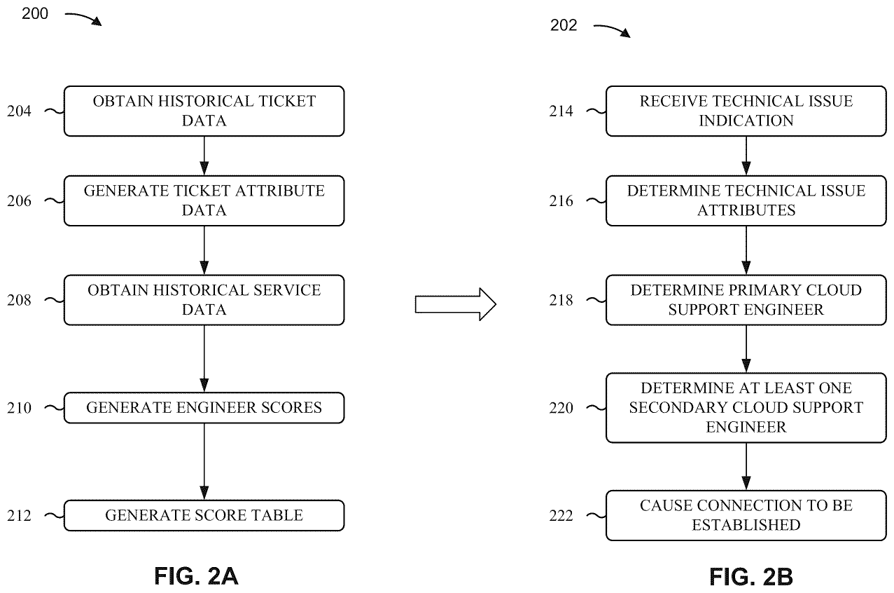

FIGS. 2A and 2B are flowcharts showing examples of processes 200 and 202 associated with establishing a service connection between devices based on historical data, as described herein. The processes 200 and 202 may be performed by any suitable system, apparatus, or device. For example, the service manager 112 shown in FIG. 1A or one or more of the components included therein, may perform one or more of the operations associated with the processes 200 and 202. Although illustrated with discrete blocks, aspects of the depicted blocks may be altered, rearranged, or performed in parallel, omitted, or additional blocks may be included.

Process 200 in FIG. 2A illustrates steps for generating engineer scores based on historical data. At 204, the process includes obtaining historical ticket data. In some implementations, the historical ticket data may be retrieved from one or more databases storing information about past technical issues and their resolutions. For example, the historical ticket data may include details such as ticket descriptions, resolution times, customer satisfaction ratings, and the engineers involved in resolving each ticket. In some implementations, the historical ticket data may also incorporate information from chat transcripts, knowledge base articles, or even social media interactions related to technical support.

At 206, the process 200 includes generating ticket attribute data based on the obtained historical ticket data. In some implementations, this step may involve using natural language processing techniques to extract relevant features from ticket descriptions. For example, the service manager may identify key terms, categorize issues into predefined groups, or determine the complexity level of each ticket. In some implementations, the ticket attribute data generation may employ machine learning algorithms to cluster similar tickets or identify patterns in the historical data that may not be immediately apparent to human analysts.

At 208, historical service data is obtained. In some implementations, this historical service data may include information about the performance of individual engineers, such as their average resolution times, customer feedback scores, or the types of issues they have successfully resolved in the past. The historical service data may be collected from various sources, including time tracking systems, customer relationship management (CRM) platforms, or performance review databases. In some implementations, the historical service data may also incorporate peer evaluations, self-assessments, or certifications achieved by the engineers.

At 210, the process 200 includes generating engineer scores based on the ticket attribute data and the historical service data. In some implementations, this step may involve applying a scoring algorithm that weighs various factors such as an engineer's expertise associated with technical issue parameters. For example, the factors may include an engineer's expertise in specific issue categories, their performance in handling issues of different complexities, and their familiarity with particular geographical regions. The scoring algorithm may use techniques such as linear regression, random forest models, or neural networks to calculate these scores. In some implementations, the engineer score generation process may employ a more dynamic approach, such as reinforcement learning, where scores are continuously updated based on recent performance.

At 212, the process 200 includes generating a score table containing the calculated engineer scores. In some implementations, this score table may be a multi-dimensional data structure that allows for quick lookup of engineer scores based on various criteria such as issue category, complexity, and geographical region. The score table may be stored in a database for easy access and regular updates. In some implementations, the score table could be implemented as a distributed data structure across multiple nodes in a cloud environment, allowing for faster access and improved scalability.

Process 202 in FIG. 2B illustrates steps for handling technical issues using the generated engineer scores. At 214, the process 202 includes receiving a technical issue indication. In some implementations, this indication may come in the form of a customer support ticket submitted through a web portal, mobile app, or email. The technical issue indication may include details such as a description of the problem, the affected service or product, and any error messages or logs provided by the customer. In some implementations, the technical issue indication could be automatically generated by monitoring systems that detect anomalies or performance issues in cloud services.

At 216, the process 202 may include determining technical issue attributes based on the received indication. In some implementations, this step may involve using the same or similar techniques as those used in step 206 of process 200. For example, natural language processing may be applied to the issue description to extract key features and categorize the issue. Machine learning models may be used to predict the likely complexity of the issue based on similar past tickets. In some implementations, this step might also involve interactive questioning systems that gather additional information from the user to refine the issue attributes.

At 218, a primary cloud support engineer is determined. In some implementations, this determination may be made by querying the score table generated in step 212 of process 200, using the technical issue attributes as search criteria. The service manager may select the engineer with the highest score matching the issue's technical issue parameter values. In some implementations, the primary engineer selection process could incorporate additional factors such as current workload, availability, or time zone alignment with the customer.

At 220, the process 202 may include determining at least one secondary cloud support engineer. In some implementations, this step may involve selecting the engineer with the next highest relevant score after the primary engineer, the engineer with the next highest relevant score, and so on. The secondary engineers may serve as a backup or collaborator on complex issues. In some implementations, the secondary engineer selection might prioritize complementary skills to the primary engineer, or may be chosen based on their history of successful collaborations with the primary engineer.

At step 222, a service connection is established between the client and support engineers. In some implementations, this may involve automatically setting up a secure communication channel, such as a chat session or video call, between the customer's device and the primary engineer's workstation. The service manager may also provide the primary engineer with relevant information about the issue and the customer's history. In some implementations, the service connection establishment might include setting up a collaborative workspace where multiple engineers, including the at least one secondary engineer, can work together on resolving the issue.

In some implementations, the processes 200 and 202 may be executed sequentially, with process 200 running periodically to update engineer scores, and process 202 being triggered each time a new technical issue is reported. In some implementations, these processes could run in parallel, with engineer scores being continuously updated in real-time as new historical data becomes available, allowing for more dynamic and responsive engineer assignments.

It should be noted that while FIGS. 2A and 2B illustrate specific sequences of steps, the order of these steps may be modified in alternative implementations. For example, in process 200, the historical ticket data and historical service data could be obtained and processed simultaneously rather than sequentially. Similarly, in process 202, the determination of primary and secondary engineers could be performed in parallel to optimize processing time.

Furthermore, additional steps not shown in FIGS. 2A and 2B may be incorporated into these processes in some implementations. For instance, process 200 might include steps for data cleaning and normalization before generating ticket attribute data or engineer scores. Process 202 could include additional steps for handling edge cases, such as when no engineers meet a certain score threshold for a particular issue.

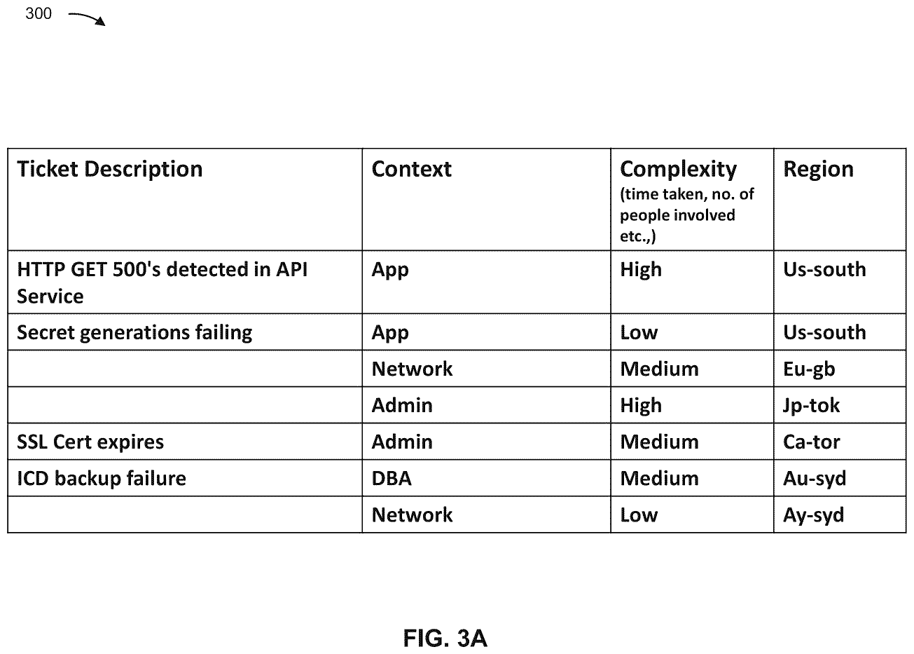

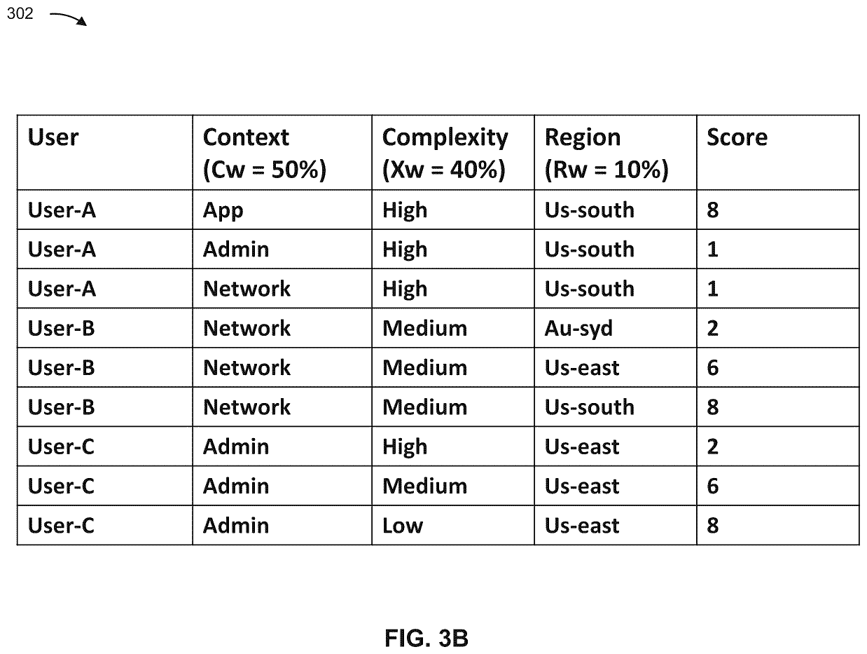

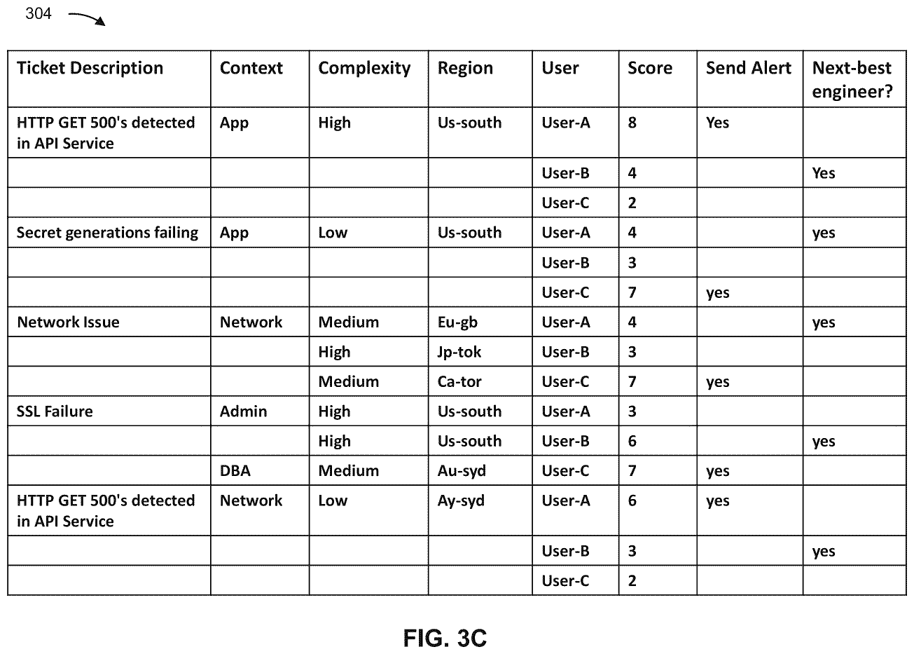

FIGS. 3A-3C are diagrams of example tables associated with establishing a service connection between devices based on historical data, as described herein. The tables shown in FIGS. 3A-3C may be generated according to the processes 200 and 202 shown in FIGS. 2A and 2B by the service manager 112 of FIG. 1A. FIG. 3A illustrates an example ticket profile table 300, FIG. 3B illustrates an example engineer profile table 302, and FIG. 3C illustrates an example score table 304. The example tables 300-304 are provided to better explain examples of the processes 200 and 202 shown in FIGS. 2A and 2B, and are not meant to limit the scope of the present disclosure or the type of tables or other data structures that may be used by the service manager 112 in various implementations of the disclosed technology.

The example ticket profile table 300 may be used to categorize and organize technical support tickets. In some implementations, the ticket profile table 300 may include columns for Ticket Description, Context (category), Complexity, and Region. The Ticket Description column may list various types of technical issues that have been reported, such as “HTTP GET 500's detected in API Service,” “Secret generations failing,” “SSL Cert expires,” and “ICD backup failure.” The Context column may categorize each ticket into different domains or areas of expertise, which may include, but are not limited to, App, Network, Admin, and DBA (Database Administrator). The Complexity column may indicate the level of difficulty associated with resolving the issue, which may be represented as High, Medium, or Low. This complexity level may be determined based on factors such as the average time taken to resolve similar issues in the past or the number of people typically involved in the resolution process. The Region column may specify the geographical location where the issue occurred, which may include regions such as Us-south, Eu-gb, Jp-tok, Ca-tor, Au-syd, and Ay-syd.

The engineer profile table 302 may be used to store information about different support engineers and their associated scores. In some implementations, the engineer profile table 302 may include columns for User, Context, Complexity, Region, and Score. The table may display data for multiple users, such as User-A, User-B, and User-C, with multiple entries for each user showing their capabilities across different contexts, complexities, and regions.

For example, the engineer profile table 302 shows that User-A has entries for App, Admin, and Network contexts, all with High complexity in the Us-south region, with scores of 8, 1, and 1 respectively. User-B has entries for Network context with Medium complexity across Au-syd, Us-east, and Us-south regions, with scores of 2, 6, and 8 respectively. User-C has entries for Admin context with High, Medium, and Low complexities in the Us-east region, with scores of 2, 6, and 8 respectively.

In some implementations, the scores in the engineer profile table 302 may be calculated using a weighted formula that takes into account various factors. For example, the formula may be represented as:

$$Score = Cw * ContextScore + Xw * ComplexityScore + Rw * RegionScore$$

where Cw, Xw, and Rw represent the weights assigned to Context, Complexity, and Region scores respectively. In the example shown in FIG. 3B, these weights may be to set to Cw=50%, Xw=40%, and Rw=10%. The formula may be adjusted to incorporate any number of different technical issue parameters.

The score table 304 may be used for identifying next-best support engineers based on various ticket parameters. In some implementations, the score table 304 may contain columns including Ticket Description, Context, Complexity, Region, User, Score, Send Alert, and Next-best engineer. The table may track different types of issues such as HTTP GET 500's detected in API Service, Secret generations failing, Network issue, SSL Failure, and others.

Each ticket in the score table 304 may be categorized by context (e.g., App, Network, Admin, DBA), complexity level (High, Medium, Low), and geographical region (e.g., Us-south, Eu-gb, Jp-tok). Users (User-A, User-B, User-C) may be assigned numerical scores ranging from 2 to 8, with higher scores indicating better capability to handle specific types of tickets. The “Send Alert” and “Next-best engineer” columns may use “yes” indicators to show when alerts should be sent and which engineers could serve as backup support.

In some implementations, the tables shown in FIGS. 3A-3C may be used in various ways to improve the efficiency and effectiveness of technical support operations. For example, when a new support ticket is received, the system may first categorize it using the ticket profile table 300. Once categorized, the system may then use the engineer profile table 302 to identify the most suitable engineer based on the ticket's context, complexity, and region. The score table 304 may then be used to determine if an alert should be sent to the primary engineer and to identify a next-best engineer who could provide assistance if needed.

Another potential use of these tables may be in workforce planning and skill development. By analyzing the engineer profile table 302, support team managers may identify areas where additional training or hiring may be needed to improve coverage across different contexts, complexities, and regions. For instance, if there are few engineers with high scores for high-complexity network issues in a particular region, this may indicate a need for targeted training or recruitment.

The score table 304 may also be used to implement a dynamic load balancing system for support tickets. As tickets are resolved, the scores for engineers may be updated in real-time, allowing the system to continuously optimize ticket assignments based on the most current performance data. This could help prevent overloading of high-performing engineers while ensuring that all engineers have opportunities to develop their skills across different types of issues.

In some implementations, the tables shown in FIGS. 3A-3C may be implemented as database structures rather than literal tables. For example, they may be represented as relational database tables, NoSQL document stores, or graph databases, depending on the specific requirements of the system. This could allow for more flexible querying and updating of the data, as well as improved scalability for large support organizations.

The system may also incorporate machine learning algorithms to continuously refine and update the categorizations and scores in these tables. For instance, natural language processing models may be used to improve the accuracy of ticket categorization over time, while reinforcement learning techniques could be applied to optimize the scoring formula based on actual resolution outcomes.

In some implementations, the tables may be extended to include additional attributes or dimensions. For example, the ticket profile table 300 could be expanded to include information about the specific cloud services or technologies involved in each issue. The engineer profile table 302 might incorporate data on an engineer's certifications, years of experience, or performance trends over time. These additional data points could further enhance the system's ability to match the right engineer to each support ticket.

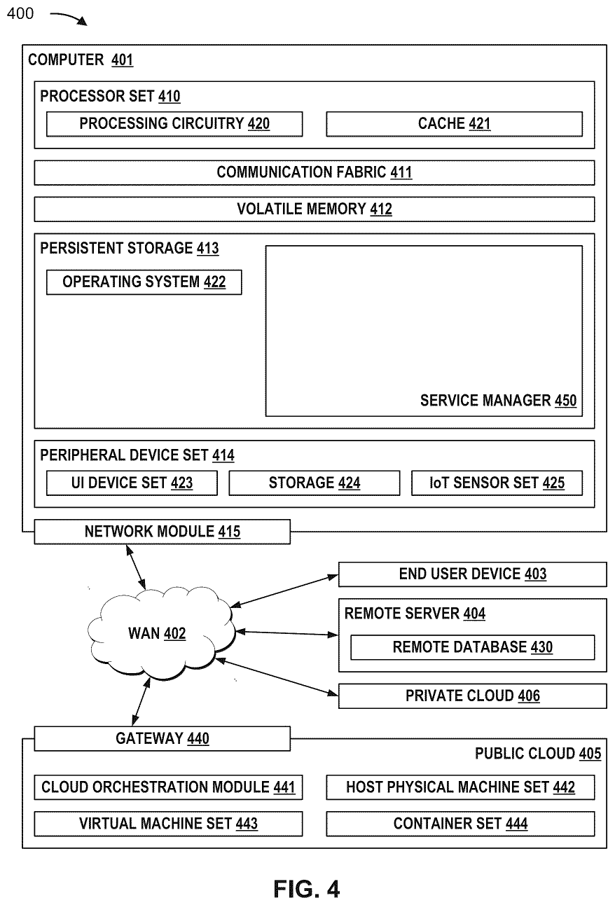

FIG. 4 is a diagram of an example computing environment 400 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as a service manager, shown in block 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. In some implementations, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

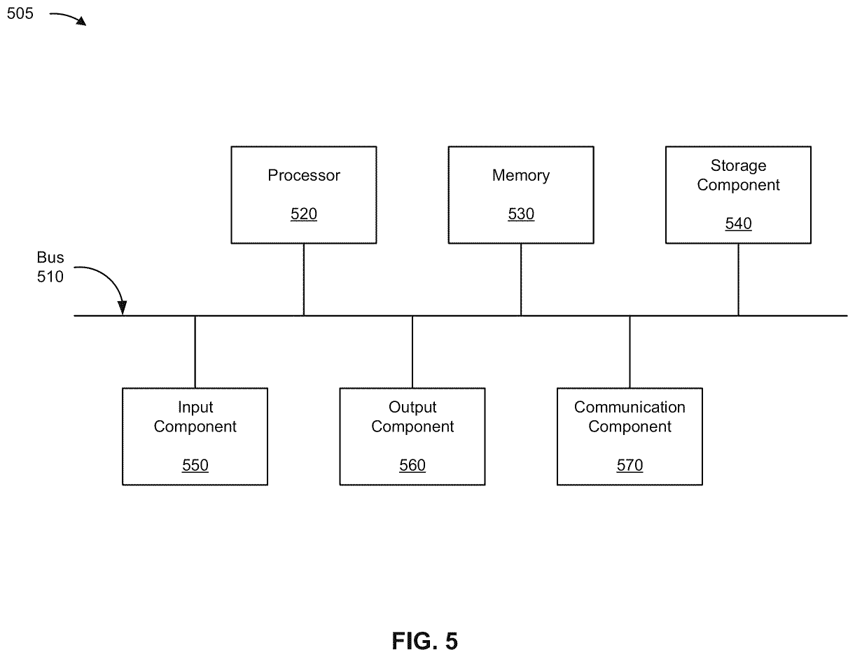

FIG. 5 is a diagram of example components of a device 505, which may implement one or more components of the computing environment 100. As shown in FIG. 5, device 505 may include a bus 510, a processor 520, a memory 530, a storage component 540, an input component 550, an output component 560, and a communication component 570.

Bus 510 includes a component that enables wired and/or wireless communication among the components of device 505. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 505. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 505 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 505 to provide output, such as via a display, a speaker, and/or one or more light-emitting diodes. Communication component 570 enables device 505 to communicate with other devices, such as via a wired connection and/or a wireless connection. For example, communication component 570 may include a receiver, a transmitter, a transceiver, a modem, a network interface card, and/or an antenna.

Device 505 may perform one or more processes described herein. For example, a non-transitory computer-readable medium (e.g., memory 530 and/or storage component 540) may store a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 505 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 505 may include additional components, fewer components, different components, or differently arranged components than those shown in FIG. 5. Additionally, or In some implementations, a set of components (e.g., one or more components) of device 505 may perform one or more functions described as being performed by another set of components of device 505.

In some implementations, the tables may be extended to include additional attributes or dimensions. For example, the ticket profile table 300 could be expanded to include information about the specific cloud services or technologies involved in each issue. The engineer profile table 302 might incorporate data on an engineer's certifications, years of experience, or performance trends over time. These additional data points could further enhance the system's ability to match the right engineer to each support ticket.

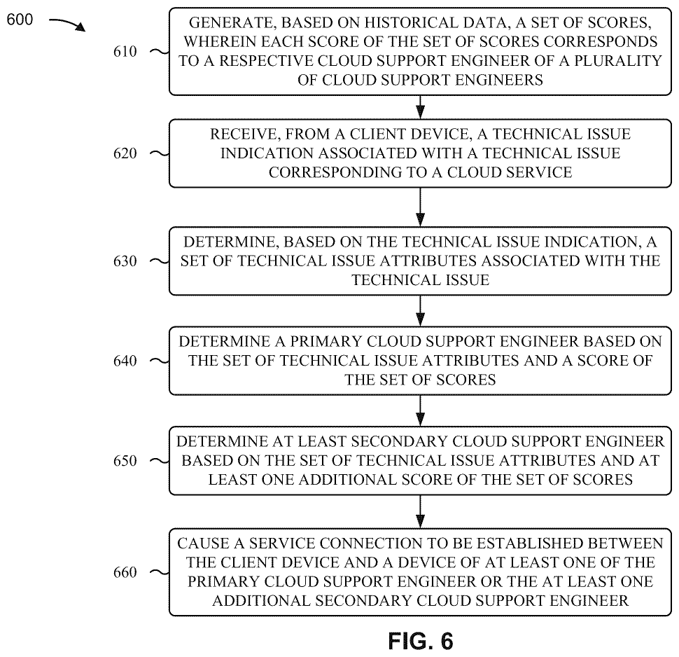

To further describe some implementations in greater detail, reference is next made to examples of processes which may be performed by or using the cloud support engineer assignment system as described herein. FIG. 6 is a flowchart of an example of a process associated with establishing a service connection between devices based on historical data. The process 600 can be executed using computing devices, such as the systems, hardware, and software described with respect to FIGS. 1A-5. The process 600 can be performed, for example, by executing a machine-readable program or other computer-executable instructions, such as routines, instructions, programs, or other code. The steps, or operations, of the process 600, or another technique, method, process, or algorithm described in connection with the implementations disclosed herein can be implemented directly in hardware, firmware, software executed by hardware, circuitry, or a combination thereof.

For simplicity of explanation, the process 600 is depicted and described herein as a series of steps or operations. However, the steps or operations of the process 600 can occur in various orders and/or concurrently. Additionally, other steps or operations not presented and described herein may be used. Furthermore, not all illustrated steps or operations may be required to implement a process in accordance with the disclosed subject matter.

At 610, the process 600 may include generating a set of scores based on historical data. For example, a service manager (e.g., the service manager 112 shown in FIG. 1A) may generate a set of scores based on historical data. In some implementations, each score of the set of scores may correspond to a respective cloud support engineer of a plurality of cloud support engineers. Each score may be indicative of an ability, of the respective cloud support engineer, to resolve one or more technical issues associated with cloud services. The historical data may be associated with a set of technical issue parameters.

In some implementations, generating the set of scores may involve using a ticket profiling engine comprising a first machine learning component to generate at least one ticket profile associated with at least one service ticket based on the historical data. Additionally, an engineer profiling engine comprising a second machine learning component may be used to generate an engineer profile associated with a cloud support engineer based on the historical data. The system may then assign at least one score of the set of scores to the at least one cloud support engineer based on the at least one ticket profile and the at least one engineer profile.

At 620, the process 600 may include receiving a technical issue indication from a client device associated with a technical issue corresponding to a cloud service. For example, the service manager 112 may receive a technical issue indication from a client device (e.g., computing device 106 or 108 shown in FIG. 1A) associated with a technical issue related to a cloud service provided by the cloud service platform 104.

In some implementations, the technical issue indication may be received by a service assignment component (e.g., service assignment component 128 shown in FIG. 1B) of the service manager. The technical issue indication may include various details such as a description of the problem, the affected service or product, and any error messages or logs provided by the client device.

At 630, the process 600 may include determining a set of technical issue attributes associated with the technical issue based on the technical issue indication. For example, the service assignment component 128 may process the technical issue indication to determine a set of technical issue attributes. In some implementations, the set of technical issue attributes may correspond to a subset of the set of technical issue parameters used in generating the set of scores.

The determination of technical issue attributes may involve using natural language processing techniques to extract relevant features from the technical issue description. For instance, the system may identify key terms, categorize the issue into predefined groups, or determine the complexity level of the ticket. In some implementations, machine learning algorithms may be employed to cluster similar tickets or identify patterns in the historical data that may not be immediately apparent.

At 640, the process 600 may include determining a primary cloud support engineer based on the set of technical issue attributes and a score of the set of scores. For example, the recommendation engine 118 (shown in FIG. 1A) may determine a primary cloud support engineer based on the set of technical issue attributes and the generated scores. This determination may involve querying a score table (e.g., score table 304 shown in FIG. 3C) using the technical issue attributes as search criteria.

In some implementations, the system may employ a multi-criteria decision-making algorithm that considers factors such as engineer expertise, workload, availability, and geographical location when making the assignment. The primary cloud support engineer may be selected based on having the highest relevant score for the particular technical issue attributes.

At 650, the process 600 may include determining at least one secondary cloud support engineer based on the set of technical issue attributes and at least one additional score of the set of scores. For example, the recommendation engine 118 may determine one or more secondary cloud support engineers based on the same set of technical issue attributes and additional scores from the set of scores.

The selection of secondary engineers may involve identifying engineers with the next highest relevant scores after the primary engineer. In some implementations, the secondary engineer selection might prioritize complementary skills to the primary engineer, or may be chosen based on their history of successful collaborations with the primary engineer. This approach can provide backup options if the primary engineer is unavailable or requires assistance, potentially leading to faster resolution times for complex issues.

At 660, the process 600 may include causing a service connection to be established between the client device and a device of at least one of the primary cloud support engineer or the at least one secondary cloud support engineer. For example, the service connection manager 130 (shown in FIG. 1B) may establish a service connection between the client device that reported the technical issue and a device associated with either the primary or a secondary cloud support engineer.

In some implementations, establishing the service connection may involve setting up a secure communication channel, such as a chat session or video call, between the client device and the support engineer's workstation. The system may also provide the support engineer with relevant information about the issue and the client's history. In some cases, the service connection establishment might include setting up a collaborative workspace where multiple engineers, including secondary engineers, can work together on resolving the issue.

After the service connection is established and the technical issue is addressed, the system may collect feedback data based on the service operation. This feedback data can be used to refine and improve the performance of the cloud support system. For instance, the feedback engine 120 (shown in FIG. 1A) may generate updated scores based on the feedback data and update the engineer profiles accordingly.

In some implementations, the process 600 may also include steps for handling edge cases. For example, if the set of technical issue categories omits a ticket issue category associated with the technical issue, the system may assign the technical issue to a default technical issue category. In such cases, the primary cloud support engineer may comprise a default engineer from a set of default engineers. The system may then obtain additional historical data based on the resolution of this new type of issue and use it to update and expand its set of technical issue categories.

Throughout the process 600, the system may continuously refine and optimize its performance through iterative learning processes. This may involve updating various components of the system based on the outcomes of resolved tickets, adjusting the weights and parameters used in the scoring formula, and improving the accuracy of the machine learning components used for ticket and engineer profiling. By doing so, the system can adapt to changing technologies, emerging issue patterns, and evolving support team dynamics, potentially leading to more effective and efficient support operations over time.

According to an aspect of the disclosure, there is provided a computer-implemented method. The method include generating a set of scores based on historical data, where each score corresponds to a respective cloud support engineer and indicates their ability to resolve technical issues associated with cloud services. The historical data may be associated with a set of technical issue parameters. The method may also include receiving a technical issue indication from a client device, determining technical issue attributes based on the indication, determining a primary and at least one secondary cloud support engineer based on the attributes and scores, and establishing a service connection between the client device and a device of at least one of the engineers. This method may improve the efficiency and accuracy of assigning appropriate support engineers to technical issues by leveraging historical data and machine learning techniques. Additionally, the method may enhance collaboration among support engineers by identifying both primary and secondary engineers for complex issues.

In embodiments, generating the set of scores may include generating a first subset of scores for the primary cloud support engineer and a second subset of scores for the secondary cloud support engineer(s). This approach may allow for more nuanced matching of engineers to specific types of technical issues, potentially improving resolution times and customer satisfaction.

In embodiments, the method may include determining a set of ticket profiles based on historical ticket data and generating a score table based on the scores and ticket profiles. The score table may be used to determine the primary cloud support engineer. This may have the technical effect of organizing and structuring historical data for more efficient engineer assignment. Additionally, it may allow for quick and accurate matching of incoming issues to the most suitable engineers.

In embodiments, the historical data may be obtained from at least one of a service chat transcript, a service desk database, a pager duty database, or a runbook repository. This approach may leverage diverse data sources to create a more comprehensive understanding of both technical issues and engineer capabilities, potentially leading to more accurate engineer assignments.

In embodiments, the method may include using machine learning components to generate ticket profiles and engineer profiles, and assigning scores based on these profiles. This may have the technical effect of automating and improving the accuracy of the profiling and scoring process. Additionally, it may allow the system to adapt and improve over time as it processes more data.

In embodiments, the method may include handling cases where a technical issue doesn't fit existing categories by assigning it to a default category and engineer. The method may also obtain additional data from resolving such issues to update and expand its set of categories. This approach may allow the system to handle novel or uncommon issues effectively while continuously improving its categorization capabilities.

In embodiments, the method may include obtaining feedback data after resolving an issue, generating updated scores based on the feedback, and updating engineer profiles accordingly. This may create a feedback loop that allows the system to continuously refine and improve its engineer assignments based on actual performance data.

In embodiments, the method may include providing an indication of the secondary cloud support engineer(s) to the primary engineer's device. This may facilitate collaboration among engineers, potentially leading to faster resolution of complex issues and improved knowledge sharing within the support team.

According to another aspect of the disclosure, there is provided, a computer system comprising a storage device, a processor set, one or more computer-readable storage media, and program instructions stored on the media to cause the processor set to perform operations. The operations may be the same as those described in the computer-implemented method. This system may provide a hardware and software infrastructure for implementing the improved cloud support engineer assignment method, allowing for efficient processing of large amounts of historical data and real-time assignment of engineers to technical issues.

In embodiments, the historical data used by the system may include at least one of historical ticket data or historical service data. This may allow the system to leverage a wide range of relevant information in making engineer assignments.

In embodiments, the historical data may include at least one of historical ticket content, a service chat transcript, a runbook repository, a pager duty database, or an employee database. This diverse set of data sources may enable the system to create more comprehensive and accurate profiles of both technical issues and support engineers.

In embodiments, the system may use machine learning components to generate ticket profiles and engineer profiles based on various data sources, and assign scores based on these profiles. This automated approach may allow for more sophisticated analysis of historical data and potentially more accurate engineer assignments.

In embodiments, the system may handle new types of technical issues by assigning them to a default category, obtaining additional data from resolving these issues, and updating its set of categories accordingly. This may allow the system to adapt to evolving technologies and new types of cloud service issues over time.

In embodiments, the system may store generated ticket profiles and engineer profiles in respective repositories. This organized storage of profiles may allow for efficient retrieval and updating of information, potentially improving the speed and accuracy of engineer assignments.

According to yet another aspect of the disclosure, there is provided a computer program product comprising one or more computer-readable storage media and program instructions stored on the media to perform operations. The operations may be the same as those described in the computer-implemented method and computer system. This computer program product may enable the implementation of the improved cloud support engineer assignment method on various computing platforms, providing flexibility in deployment and integration with existing support systems.

In embodiments, the computer program product may include operations for generating ticket profiles and engineer profiles using machine learning components, obtaining feedback data, and refining the machine learning components based on the feedback data. This may create a self-improving system that can adapt to changing patterns in technical issues and engineer performance over time.

In embodiments, the computer program product may use separate sets of machine learning components for generating ticket profiles and engineer profiles. This may allow for specialized processing of different types of data, potentially leading to more accurate profiling and, consequently, more effective engineer assignments.

In embodiments, the computer program product may use a third set of machine learning components to determine technical issue attributes from incoming issue indications. This automated approach to issue categorization may improve the speed and consistency of the initial triage process.

In embodiments, the computer program product may calculate scores using a formula that includes weighted scores for issue category, complexity, and geographical region. This nuanced scoring approach may allow for more precise matching of engineers to specific types of technical issues, potentially improving resolution times and customer satisfaction.

In one implementation, the cloud support engineer assignment system effectively improves the efficiency of resolving technical issues in a large-scale cloud computing environment. When a customer reports an HTTP 500 error in an API service, the system immediately analyzes the ticket using natural language processing techniques. The ticket profiling engine, utilizing machine learning algorithms, categorizes this as a high-complexity application issue in the Us-south region. Simultaneously, the engineer profiling engine evaluates the historical performance data of available support engineers.

The system identifies User-A as the primary engineer with a score of 8 for high-complexity application issues in the Us-south region. It also selects User-B as a secondary engineer with a score of 6 for network-related issues, anticipating potential network components in the API error. The service connection manager establishes a secure communication channel between the customer's device and User-A's workstation, while also notifying User-B of the ongoing issue. This collaborative approach allows for rapid problem-solving, with User-A leveraging their expertise in application errors and User-B providing insights on potential network-related aspects.

As the issue is resolved, the feedback engine collects data on the resolution process, including the time taken, steps performed, and customer satisfaction rating. This information is then used to update the scores in the engineer profile table. For instance, if User-A successfully resolves the issue quickly, their score for high-complexity application issues in the Us-south region might increase from 8 to 9. Conversely, if the resolution required significant input from User-B on network-related aspects, their score for application issues might increase from 1 to 2, reflecting their growing expertise in this area.

This dynamic scoring system ensures that the assignment of support engineers continually improves over time, adapting to the evolving skills of the support team and the changing nature of cloud service issues. As a result, the system demonstrates its effectiveness in real-world cloud support scenarios, leading to faster resolution times, improved customer satisfaction, and more efficient utilization of support engineer expertise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
generating, based on historical data, a set of scores, wherein each score of the set of scores corresponds to a respective cloud support engineer of a plurality of cloud support engineers,
wherein each score is indicative of an ability, of the respective cloud support engineer, to resolve one or more technical issues associated with cloud services, and
wherein the historical data is associated with a set of technical issue parameters;
receiving, from a client device, a technical issue indication associated with a technical issue corresponding to a cloud service;
determining, based on the technical issue indication, a set of technical issue attributes associated with the technical issue, the set of technical issue attributes corresponding to a subset of the set of technical issue parameters;
determining a primary cloud support engineer based on the set of technical issue attributes and a score of the set of scores;
determining at least one secondary cloud support engineer based on the set of technical issue attributes and at least one additional score of the set of scores; and
causing a service connection to be established between the client device and a device of at least one of the primary cloud support engineer or the at least one secondary cloud support engineer.

2. The computer-implemented method of claim 1, wherein generating the set of scores comprises:
generating, based on the historical data, a first subset of scores of the set of scores, wherein the first subset of scores corresponds to the primary cloud support engineer and includes the score; and
generating, based on the historical data, a second subset of scores of the set of scores, wherein the second subset of scores corresponds to the at least one secondary cloud support engineer and includes the at least one additional score.

3. The computer-implemented method of claim 1, wherein the historical data comprises historical ticket data and historical service data, the method further comprising:
determining a set of ticket profiles based on the set of historical ticket data; and
generating a score table based on the set of scores and the set of ticket profiles.

4. The computer-implemented method of claim 1, wherein the historical data comprises historical ticket data and historical service data, the method further comprising:
determining a set of ticket profiles based on the set of historical ticket data; and
generating a score table based on the set of scores and the set of ticket profiles, wherein the primary cloud support engineer is determined based on the score table.

5. The computer-implemented method of claim 1, further comprising obtaining the historical data from at least one of a service chat transcript, a service desk database, a pager duty database, or a runbook repository.

6. The computer-implemented method of claim 1, further comprising:
generating, using a ticket profiling engine comprising a first machine learning component, at least one ticket profile, associated with at least one service ticket, based on the historical data;
generating, using an engineer profiling engine comprising a second machine learning component, an engineer profile associated with a cloud support engineer based on the historical data; and
assigning at least one score of the set of scores to the at least one cloud support engineer based on the at least one ticket profile and the at least one engineer profile.

7. The computer-implemented method of claim 1, wherein the set of technical issue parameters comprises a set of technical issue categories, the method further comprising:
determining that the set of technical issue categories omits a ticket issue category associated with the technical issue; and
assigning the technical issue to a default technical issue category, wherein the primary cloud support engineer comprises a default engineer of a set of default engineers.

8. The computer-implemented method of claim 5, further comprising:
obtaining feedback data based on a service operation associated with resolving the technical issue;
generating, based on the feedback data, at least one updated score associated with at least one of the score or the at least one additional score; and
updating at least one of an engineer profile associated with the primary cloud support engineer or at least one additional engineer profile associated with the at least one secondary cloud support engineer to include the at least one updated score.

9. The computer-implemented method of claim 1, wherein causing the service connection to be established between the client device and the device of at least one of the primary cloud support engineer or the at least one secondary cloud support engineer comprises causing the client device to be connected to the device of the primary cloud support engineer, the method further comprising:
providing, to the device of the primary cloud support engineer, an indication of the at least one secondary cloud support engineer.

10. A computer system comprising:
a storage device; and
a processor set;
one or more computer-readable storage media; and
program instructions stored on the one or more computer-readable storage media to cause the processor set to perform operations comprising:
generating, based on historical data, a set of scores, wherein each score of the set of scores corresponds to a respective cloud support engineer of a plurality of cloud support engineers,
wherein each score is indicative of an ability, of the respective cloud support engineer, to resolve one or more technical issues associated with cloud services, and
wherein the historical data is associated with a set of technical issue parameters;
receiving, from a client device, a technical issue indication associated with a technical issue corresponding to a cloud service;
determining, based on the technical issue indication, a set of technical issue attributes associated with the technical issue, the set of technical issue attributes corresponding to a subset of the set of technical issue parameters;
determining a primary cloud support engineer based on the set of technical issue attributes and a score of the set of scores;
determining at least one secondary cloud support engineer based on the set of technical issue attributes and at least one additional score of the set of scores; and
causing a service connection to be established between the client device and a device of at least one of the primary cloud support engineer or the at least one secondary cloud support engineer.

11. The computer system of claim 10, wherein the historical data comprises at least one of historical ticket data or historical service data.

12. The computer system of claim 10, wherein the historical data comprises at least one of historical ticket content, a service chat transcript, a runbook repository, a pager duty database, or an employee database.

13. The computer system of claim 10, the operations further comprising:
generating, using a ticket profiling engine comprising a first machine learning component, at least one ticket profile, associated with at least one service ticket, based on at least one of historical ticket content, a service chat transcript, or a runbook repository;
generating, using an engineer profiling engine comprising a second machine learning component, at least one engineer profile associated with at least one cloud support engineer based on at least one of a service chat transcript, a pager duty database, an employee database, or the historical ticket content; and
assigning at least one score of the set of scores to the at least one cloud support engineer based on the at least one ticket profile and the at least one engineer profile.

14. The computer system of claim 10, wherein the set of technical issue parameters comprises a set of technical issue categories, the operations further comprising:
determining that the set of technical issue categories omits a ticket issue category associated with the technical issue;
assigning the technical issue to a default technical issue category, wherein the primary cloud support engineer comprises a default engineer of a set of default engineers;
obtaining, based on a service operation associated with the technical issue, additional historical data; and
adding, based on the additional historical data, a technical issue category to the set of technical issue categories.

15. The computer system of claim 10, the operations further comprising:
generating, using a ticket profiling engine comprising a first machine learning component, at least one ticket profile, associated with at least one service ticket, based on at least one of historical ticket content, a service chat transcript, or a runbook repository;
storing the at least one ticket profile in a ticket profile repository;
generating, using an engineer profiling engine comprising a second machine learning component, at least one engineer profile, associated with at least one cloud support engineer, based on at least one of a service chat transcript, a pager duty database, an employee database, or the historical ticket content; and
storing the at least one engineer profile in an engineer profile repository.

16. A computer program product comprising:
one or more computer-readable storage media; and
program instructions stored on the one or more computer readable storage media to perform operations comprising:
generating, based on historical data, a set of scores, wherein each score of the set of scores corresponds to a respective cloud support engineer of a plurality of cloud support engineers,
wherein each score is indicative of an ability, of the respective cloud support engineer, to resolve one or more technical issues associated with cloud services, and
wherein the historical data is associated with a set of technical issue parameters;
receiving, from a client device, a technical issue indication associated with a technical issue corresponding to a cloud service;
determining, based on the technical issue indication, a set of technical issue attributes associated with the technical issue, the set of technical issue attributes corresponding to a subset of the set of technical issue parameters;
determining a primary cloud support engineer based on the set of technical issue attributes and a score of the set of scores;
determining at least one secondary cloud support engineer based on the set of technical issue attributes and at least one additional score of the set of scores; and
causing a service connection to be established between the client device and a device of at least one of the primary cloud support engineer or the at least one secondary cloud support engineer.

17. The computer program product of claim 16, the operations further comprising:
generating, using a first machine learning component, a set of ticket profiles based on the historical data;
generating, using a second machine learning component, a set of engineer profiles based on the historical data;
obtaining feedback data based on a service operation associated with resolving the technical issue; and
refining at least one of the first machine learning component or the second machine learning component based on the feedback data.

18. The computer program product of claim 16, wherein generating the set of scores comprises:
generating, using a first set of machine learning components, a set of ticket profiles based on the historical data; and
generating, using a second set of machine learning components, a set of engineer profiles based on the historical data.

19. The computer program product of claim 16, the operations further comprising:
generating, using a first set of machine learning components, a set of ticket profiles based on the historical data; and
generating, using a second set of machine learning components, a set of engineer profiles based on the historical data, wherein generating the set of scores comprises assigning, based on a formula, the set of scores to the set of engineer profiles, and wherein determining the set of technical issue attributes associated with the technical issue comprises determining that the set of technical issue attributes using a third set of machine learning components.

20. The computer program product of claim 16, the operations further comprising:
generating, using a first set of machine learning components, a set of ticket profiles based on the historical data; and
generating, using a second set of machine learning components, a set of engineer profiles based on the historical data, wherein generating the set of scores comprises calculating, based on a formula, the set of scores, wherein the formula comprises a sum of a weighted category score, a weighted issue complexity score, and a weighted geographical region score.
